(19) United States
(12) Patent Application Publication
(10) Pub. No.: US 2006/0103583 A1
(43) Pub. Date: May 18, 2006

(54) Evanescent microwave microscopy probe and methodology

(76) Inventors: Richard A. Kleismit, Brookville, OH (US); Gregory Kozlowski, Springboro, OH (US)

Correspondence Address: ROETZEL AND ANDRESS, 222 SOUTH MAIN STREET, AKRON, OH, 44308, US

(21) Appl. No.: 11/255,497

(22) Filed: Oct. 20, 2005

Related U.S. Application Data
(60) Provisional application No. 60/620,592, filed on Oct. 20, 2004.

(51) Int. Cl. H01Q 13/00

(52) U.S. Cl. 343/785

(57) ABSTRACT

An evanescent microwave microscopy probe substantially as described in the above specification and in the accompanying drawings including one or more of the novel features described in the above specification and drawings.

This application hereby claims priority to U.S. Provisional Patent Application No. 60/620,592 filed on Oct. 20, 2004.

### BACKGROUND OF THE INVENTION

The theoretical model for the change in resonant frequency of the resonator assembly as a function of the complex permittivity of materials and the probe-sample geometry has been described. In contrast to existing theoretical description, the method of the present invention is independent of electrical properties of the material, and applies to dielectrics, conductors and superconductors. The method of the present invention is more general than prior methods. This generality is achieved by using perturbation theory imposed on electric field in the vicinity of the probe-tip. Prior methods assumed calculations based on capacitance due to the gap between the spherical conducting tip and perfect conducting surface of the sample. Reaction of resonator probe on the electric field existing in the gap and the sample does not lead necessarily to results predicted by the prior methods. In order to achieve their results from our theory, we need to restrict our model by imposing additional condition on the reaction of the resonator probe on the fields existing in the area outside the tip. Namely, the coefficients in (9) and (10) should be the same (A′=A) to get their results. The advantage of this assumption gives a smooth transition between insulators and ideal conductors by assuming b=1 in (8). The physics of superconductors are studied at the quantum level, but the macroscopic properties of the material from which it is derived must be consistent within the classical theory of electromagnetics. The theory and analysis proposed here allows the solution of the classical electrodynamic boundary value problem concerning a superconductor modeled as a dielectric with a large, negative real part for the complex permittivity, which can be associated with the persistent current.

Prior work in this area used a shunt series combination. The maximum Q is solely determined by resistance of the series R-L-C probe equivalent circuit and tuning network. However, sapphire capacitors have an intrinsic equivalent series resistance (ESR). The present invention achieves substantially higher Q values than that of the prior art by arranging the sapphire tuning capacitors in parallel. By doing so the resistance is cut by 50% compared to a single shunt capacitor. Accordingly, this results in very high Q values and correspondingly high sensitivity.

### BRIEF SUMMARY OF THE INVENTION

The present invention relates to near field microscopy and, more particularly to an evanescent microwave microscopy probe for use in near field microscopy and methodology for investigating the complex permittivity of a material through evanescent microwave technology. The probe comprises a low loss, apertured, coaxial resonator that may be tuned over a large bandwidth by a parallel shunt sapphire tuning network. The transmission line of the probe utilizes high grade paraffin, offering relatively low loss tangent and a very close dielectric match within the line. A chemically sharpened tip extends slightly past the end aperture of the probe and emits a purely evanescent field. This sensor is extremely sensitive, achieving Q values in excess of 0.5×10⁶ and a spatial resolution of 1.0×10⁻⁶ meters.

The physical construction of the probe according to the present invention dictates a purely evanescent field emanating from its tip. As a result, in the context of use in quantitative microscopy, it is not necessary to provide additional hardware and methodology to separate a propagative component from the field. The probe also allows an extremely low loss impedance match to standardized equipment. The low loss coaxial resonator of the present invention theoretically has an infinite bandwidth but is practically governed by the constraints of physical length and source bandwidth. The evanescent mode bandwidth is controlled by the aperture diameter, which is quite large compared with state of the art designs. The probe of the present invention also utilizes a shunt capacitive tuning network characterized by a low equivalent series resistance. As a result, the probe of the present invention, provides for large resonant frequency selection range and extremely high Q values.

### BRIEF DESCRIPTION OF THE DRAWINGS

FIG. 1 is a schematic representation of a cross-section of a probe in accordance with the present invention,

FIG. 2 is a block diagram of a microscope in accordance with the present invention,

FIG. 3 is a diagram of the probe and coupling network,

FIG. 4 is a diagram showing the method of images,

FIG. 5 is a scanning electron micrograph of a superconducting film having two distinct regions,

FIG. 6 is a plot of susceptibility loss versus temperature for a superconducting film,

FIG. 7 is a pair of plots of resonant frequency versus distance between the probe tip and the sample, wherein the data is collected at 79.4 K and 298 K,

FIG. 8 is a plot showing the change in Q for the superconducting film at 79.4 K,

FIG. 9 is a photograph of an embodiment of the microwave microscopy apparatus of the present invention,

FIG. 10 is a photograph of Ti—Au lines etched on sapphire at 20× magnification,

FIG. 11 is a plot of the change in Q,

FIG. 12 is a plot of the change in reflection coefficient images,

FIG. 13 is a circuit diagram representing the probe connected to a superconductor,

FIG. 14 is a plot showing the change in Q for a superconducting film in junction area of 6° bi-crystal

FIG. 15 is a plot showing the tuned resonance with the probe tip one micron above the SrTiO₃ crystal sample at 300 K,

FIG. 16 is a plot showing the frequency-shifted resonance with the probe tip about 1 micron from the SrTiO₃ crystal sample at 302 K,

### DETAILED DESCRIPTION OF THE INVENTION

The present invention generally relates to a microwave probe for microwave microscopy and a method of using the same for generating high quality microwave data. More particularly, the apparatus and method of the present invention can be used to take high-precision, low-noise, measurements of material parameters such as permittivity, permeability, and conductively.

The probe can be used for the characterization of local electromagnetic properties of materials. The resonator-intrinsic, spatial resolution is experimentally demonstrated herein. A first-order estimation of the sensitivity related to the probe tip-sample interaction for conductors, dielectrics, and superconductors is provided. An estimation of the sensitivity inherent to the resonant probe is presented. The probe is sensitive in the range of theoretically estimated values, and has micrometer-scale resolution.

Probe Theory of Operation

In the field of evanescent microwave microscopy, the tip of the probe operates in close proximity of the sample, where the tip radius and effective field distribution range are much smaller than the resonator excitation wavelength. The propagating field exciting resonance in the probe can be ignored and the probe tip-sample interaction can be treated as quasi-static. This can be used for localized measurements and images with resolved features governed essentially by the characteristic size of the tip. The field distribution from the probe tip extends outward a short distance, and as a material is entered into the near field of the tip, it will, interact with the evanescent field, perturbing the resonance of the probe. This perturbation is linked to the resonant structure of the probe through the air gap coupling capacitance C_{C} between the tip and the material. This results in the loading of the resonant probe and alters the resonant frequency fᵣ, quality factor Q, and reflection coefficient S₁₁ of the resonator.

If the air gap distance from tip to sample is held constant, the fᵣ, Q, and S₁₁ variations related to the microwave properties of the sample can be mapped as the probe tip is scanned over the sample. The microwave properties of a material are functions of permittivity ε, permeability μ, and conductivity σ.

Basic Probe Structure

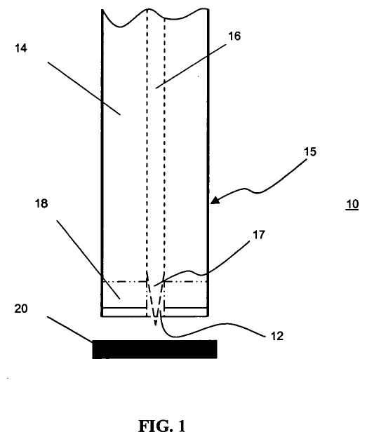

Referring to FIG. 1, the microwave probe 10 of the present invention can be constructed from a standard 0.085″ semi-ridged coaxial transmission line. The probe 10 is based on an end-wall aperture coaxial transmission line, where the resonator behaves as a series resonant circuit for odd multiples of λ/4.

In constructing the probe 10, the center conductor is removed along with the poly(tetrafluoroethylene) insulator and replaced with high purity paraffin 14. However, the invention is not restricted to paraffin and alternative materials can be used. For example, alternative materials within the scope of the present invention include, without limitation, magnesium oxide, titanium oxide, boron nitride, aluminas, and various organic polymeric materials.

Fashioning the probe 10 according to the foregoing paragraph results in a coaxial wave guide probe 10 rather that an open cavity. A copper aperture, having a thickness of about 0.010″, is soldered inside the outer shield 15, creating an end-wall aperture 12. A chemically sharpened tip 17 is mounted on the center conductor 16 and electroplated with silver. The transmission line resonator is then reconstructed by casting the sharpened, plated, center conductor 16 inside the outer shield 15 with high purity paraffin 14. A short section of the original poly(tetrafluoroethylene) shielding replaces the paraffin 14 at the sharpened end of the coax, and is located directly above the end-wall aperture 12. This poly(tetrafluoroethylene) plug 18 is used to maintain tip-aperture alignment. The sharpened point 17 of the center conductor 16 extends beyond the shielded end-wall aperture 12 of the resonator by approximately 0.001″ or less. The purely evanescent probing field is radiated from the sharpened tip 17. In this manner, as the center conductor 16 radius decreases, the spatial resolution of the probe increases due to localization of the interaction between the tip 17 and sample 20.

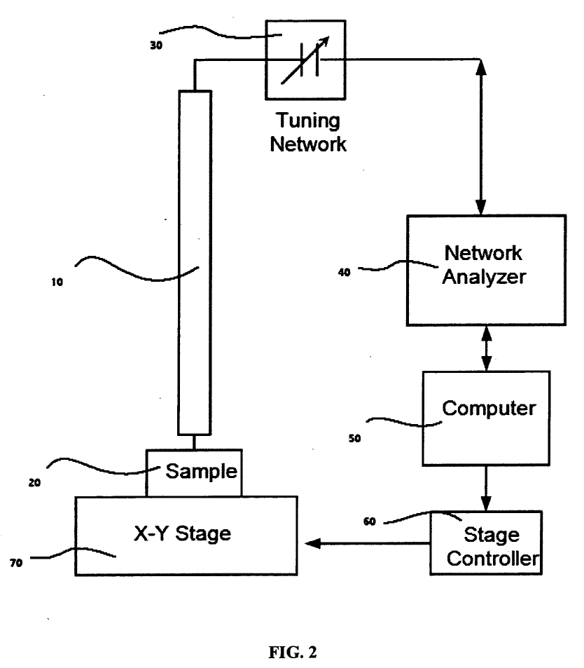

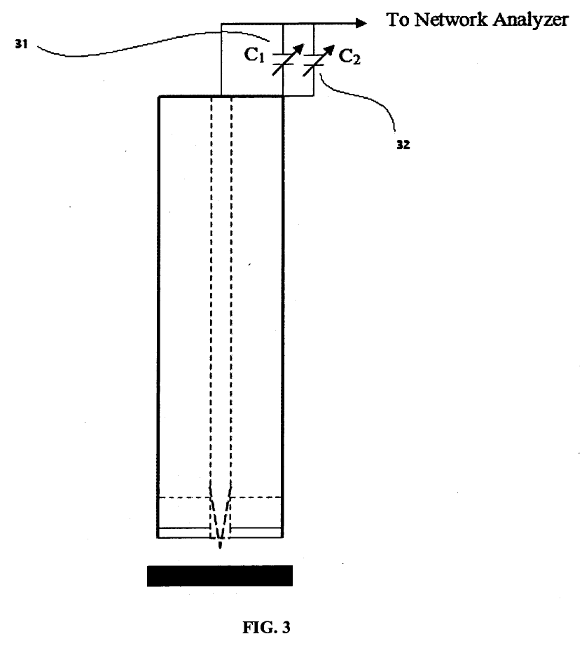

Referring to FIG. 2, the microwave excitation frequency of the resonant probe 10 can be varied in the network analyzer 40 bandwidth from 1 to 40 GHz and is tuned by external capacitors 30. As is further illustrated in FIG. 3, the microscope probe can be coupled to the network analyzer 40 through tuning network capacitors C₁31 and C₂ 32, which are connected to the center conductor 16 and to the outer shield 15.

A block diagram of the microwave microscopy system is shown in FIG. 2. The changes in the probe's resonant frequency, quality factor (Q), and reflection coefficient are tracked by a Hewlett-Packard 8722ES network analyzer 40 through S₁₁ port measurements, as the probe 10 moves above the sample surface 20. The microwave excitation frequency of the resonant probe 10 can be varied within the bandwidth of the network analyzer 40 and is tuned to critical coupling by the tuning assembly 30. The tuning assembly 30 comprises two variable 2.5 to 8 pF capacitors 31, 32. The tuning network has one capacitor C₁ 31 connected in-line with the center conductor 16, and the other capacitor C₂ 32 is connected from center conductor 16 to ground.

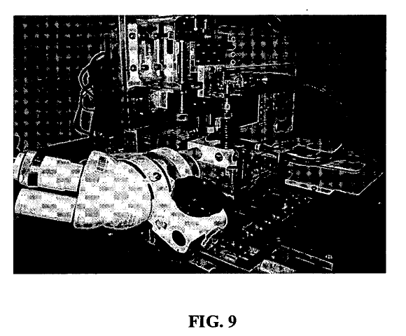

The X-Y axis stage 70 is driven by Coherent® optical encoded DC linear actuators. The probe 10 is frame-mounted to a Z-axis linear actuator assembly and the height at which the probe 10 is above the sample 20 can be precisely set. The X-Y stage actuators, network analyzer 40, and data acquisition and collection are controlled by the computer 50. The program that interfaces to the X-Y stage actuators, serial port communications, 8722ES GPIB interface, and data acquisition is written in National Instruments Labview® software. The complete evanescent microwave scanning system is mounted on a vibration-dampening table (see FIG. 9).

According to one embodiment of the present invention, the external tuning capacitor assembly 30 consists of two thermally compensated sapphire capacitors in a shunt configuration. If a shunt is placed near the end of the resonator then the Q of the resonator will theoretically approach infinity. Sapphire capacitors are advantageous because they exhibit frequency invariance up to approximately 10 GHz. The capacitors 31, 32 are preferably variable from, for example, about 4.5 to 8.0 Picofarads. The position of the capacitors 31, 32 in the tuning assembly 30 is optimized to reduce interaction. Shielding techniques may also be employed to limit external interaction and leakage.

Mathematical Model and Methodology

As is noted above, the present invention also relates to methodology for investigating the complex permittivity of a material through evanescent microwave technology. More particularly, the methodology taught herein is a scheme for investigating the complex permittivity of a material, independent of its electrical properties, through evanescent microwave spectroscopy.

The extraction of quantitative data through evanescent microwave microscopy requires a detailed configuration of the field outside the probe-tip region. The solution of this field will clearly relate the perturbed signal to the probe tip-sample distance and physical material properties. It is essential that the mode of the field generated at the tip be evanescent, since mixed mode consisting of evanescent and propagative will prevent quantitative measurements. The propagative wave's contribution to the tip-sample signal depends on the electrical properties of the sample, and limits the resolution of the microscopy sensor.

In analyzing conductors quantitatively the probe tip can be modeled as a conducting sphere and the sample as an ideal conductor. The tip and sample separation represents a capacitor with capacitance C_{c}, resulting in a resonant frequency shift that is proportional to the variation in C_{c}. When a conducting material is placed near the tip an interaction will cause charge and field redistribution. The method of images can be applied to model this redistribution of the field and requires a series iteration of two image charges. This variation of the tip-sample capacitance results in a shift of the resonant frequency of the resonator.

To quantitatively analyze dielectric materials, an analysis incorporating the method of images can be applied. Also, the resonator tip is represented as a charged conducting sphere with potential V₀ and when closely placed over a dielectric material the dielectric will be polarized by the electric field. This dielectric reaction to the tip causes a redistribution of charge on the tip in order to maintain the equipotential surface of the sphere and also results in a shift in frequency of the resonator. Applying the method of images to model the field redistribution requires a series of three image charges in an iterative process to meet boundary conditions at probe tip and the dielectric sample surface.

In this unified approach, perturbation theory for microwave resonators is applied dealing only with the field distribution outside the tip. The expression for the resonant frequency shift due to the presence of a material is

$$\frac{Δ f}{{f}_{0}} = - \frac{{\int }_{V} [ ( Δ ɛ ) ( \overline{E} \cdot {\overline{E}}_{0} ) + ( Δ μ ) ( \overline{H} \cdot {\overline{H}}_{0} ) ] ⅆ V}{{\int }_{V} ( {ɛ}_{0} {\overline{E}}_{0}^{2} + {μ}_{0} {\overline{H}}_{0}^{2} ) ⅆ V} = \frac{f - {f}_{0}}{{f}_{0}} , \qquad ( 1 )$$

where \overline{E} and \overline{H} are the perturbed fields, V is the volume of a region outside the resonator tip, f is the resonant frequency and f₀ is the reference frequency. The unperturbed field is given by

$${E}_{0} ( r , z ) = \frac{q}{4 {πɛ}_{0}} \frac{[ r \hat{r} + ( z + {a}_{1}^{′} {r}_{0} ) \hat{z} ]}{{[ {r}^{2} + {( z + {a}_{1}^{′} {r}_{0} )}^{2} ]}^{3 / 2}} , \vert {\overline{H}}_{0} \vert = \sqrt{\frac{{ɛ}_{0}}{{μ}_{0}}} \vert {\overline{E}}_{0} \vert \qquad ( 2 )$$

where
a′₁=r₀+g (3)
with radius r₀ of the spherical tip and g as the gap between the tip and surface of the sample. The potential V₀ on the spherical tip is given by

$${V}_{0} = \frac{q}{4 {πɛ}_{0} {r}_{0}} . \qquad ( 4 )$$

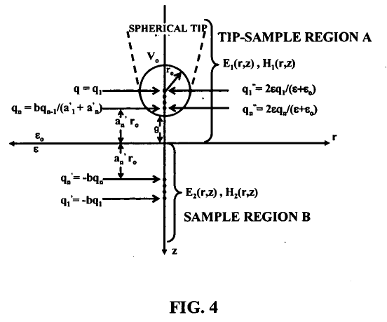

By using the method of images (see FIG. 4), the perturbed electric field in the tip-sample region and the sample volume (where r₀ is much smaller than the sample thickness) can be derived as

$$\begin{matrix}{\overline{E}}_{1} ( r , z ) = \frac{q}{4 {πɛ}_{0}} {\sum }_{n = 1}^{∞} {q}_{n} \{ \frac{[ r \hat{r} + ( z + {a}_{n}^{′} {r}_{0} ) \hat{z} ]}{{[ {r}^{2} + {( z + {a}_{n}^{′} {r}_{0} )}^{2} ]}^{3 / 2}} - b \frac{[ r \hat{r} + ( z - {a}_{n}^{′} {r}_{0} ) \hat{z} ]}{{[ {r}^{2} + {( z - {a}_{n}^{′} r )}^{2} ]}^{3 / 2}} \} , \\ \vert {\overline{H}}_{1} \vert = \sqrt{\frac{{ɛ}_{0}}{{μ}_{0}}} \vert {\overline{E}}_{1} \vert , & ( 5 ) \\ {\overline{E}}_{2} ( r , z ) = \frac{1}{2 π ( ɛ + {ɛ}_{0} )} {\sum }_{n = 1}^{∞} {q}_{n} \frac{[ r \hat{r} + ( z + {a}_{n}^{′} {r}_{0} ) \hat{z} ]}{{[ {r}^{2} + {( z + {a}_{n}^{′} {r}_{0} )}^{2} ]}^{3 / 2}} , \vert {\overline{H}}_{2} \vert = \sqrt{\frac{ɛ}{μ}} \vert {\overline{E}}_{2} \vert , & ( 6 )\end{matrix}$$

where μ is real and

$${a}_{n}^{′} = {a}_{1}^{′} - \frac{1}{{a}_{1}^{′} + {a}_{n - 1}^{′}} , {q}_{n} = {t}_{n} q , {t}_{n} = \frac{{bt}_{n - 1}}{{a}_{1}^{′} + {a}_{n - 1}^{′}} , \\ {t}_{1} = 1 , b = \frac{ɛ - {ɛ}_{0}}{ɛ + {ɛ}_{0}} , ɛ = {ɛ}^{′} + {ⅈɛ}^{″} . \qquad ( 7 )$$

Importantly, for a tip in free space ε=ε₀ and μ=μ₀ at the location r=0 and z=−g−r₀, \overline{E}₀=\overline{E}₁=\overline{E}₂ and \overline{H}₀=\overline{H}₁=\overline{H}₂, confirming the asymptotic behavior in (2), (5), and (6). By integrating the unperturbed electric field in (2) and the perturbed electric fields in (5) and (6) over a region V outside the spherical tip the frequency shift (1) becomes

$${( \frac{Δ f}{{f}_{0}} )}_{TOTAL} = {( \frac{Δ f}{{f}_{0}} )}_{1} + {( \frac{Δ f}{{f}_{0}} )}_{2} = - A {\sum }_{n = 1}^{∞} {t}_{n} \{ 1 - \frac{1}{2} ( 1 - b ) \frac{1}{{a}_{1}^{′} + {a}_{n - 1}^{′}} \} - A ( \frac{Δμ}{Δɛ} ) \sqrt{\frac{ɛ}{μ}} \sqrt{\frac{{ɛ}_{0}}{{μ}_{0}}} {\sum }_{n = 1}^{∞} {t}_{n} \frac{b}{{a}_{1}^{′} + {a}_{n - 1}^{′}} , ( A = {A}^{′} ) , \qquad ( 8 )$$

where

$$\begin{matrix}{( \frac{Δ f}{{f}_{0}} )}_{1} = - {A}^{′} {\sum }_{n = 1}^{∞} {t}_{n} \{ 1 - \frac{1}{2} ( 1 + b ) \frac{1}{{a}_{1}^{′} + {a}_{n - 1}^{′}} \} , \\ Reg . A , Δμ = 0 and & ( 9 ) \\ {( \frac{Δ f}{{f}_{0}} )}_{2} = - A ( 1 + \frac{Δμ}{Δɛ} \sqrt{\frac{ɛ}{μ}} \sqrt{\frac{{ɛ}_{0}}{{μ}_{0}}} ) {\sum }_{n = 1}^{∞} {t}_{n} \frac{b}{{a}_{1}^{′} + {a}_{n - 1}^{′}} , Reg . B . & ( 10 )\end{matrix}$$

Parameters A and A′ are constants determined by the geometry of the tip-resonator assembly. Taking into account the real part of (8), we can fit this analytical expression, with our experimental data.

In one embodiment the method of the present invention is used to measure the dielectric properties of the superconductor YBa₂Cu₃O_{7-δ}. A superconductor can be treated as a dielectric material with a negative dielectric constant rather than a low loss conductor. In this embodiment the probe 10 comprises a tuned, end-wall apertured coaxial transmission line. The resonator probe 10 is coupled to a network analyzer 40 through a tuning network 30 and coupled to the sample 20 (see FIG. 2). When the resonator tip 12 is in close proximity to the sample 20, the resonator's frequency f will shift. In measuring the frequency shift, the probe resonant frequency reference is set at a fixed distance above the sample. This distance between probe tip 12 and sample 20 is sufficient to assure that the evanescent field emanating from the tip 12 will not interact with the sample 20. The field dispersion from the probe tip extends outward a short distance with the amplitude of the evanescent field decaying exponentially. As a sample 20 enters the near field of the probe 10, it will interact with the evanescent field, thereby perturbing it. This results in loading the resonator via the coupling and is considered part of the resonant circuit resulting in losses added to the system, which decreases the microscope resonant frequency. The measured frequency shift versus tip-sample separation g generates a transfer function relating Δf to Δg, which is best fit with an electrostatic field model generated from the method of images to extract the complex permittivity values.

In a variation of the foregoing embodiment, the evanescent microwave microscopy system is adapted for making cryogenic measurements. A miniature single-stage Joule-Thompson cryogenic system is fixed to the X-Y stage 70. The microwave probe is fitted through a bellows, which provides a vacuum seal and allows the probe to move freely over the sample, which is mounted on the cryogenic finger directly below the probe.

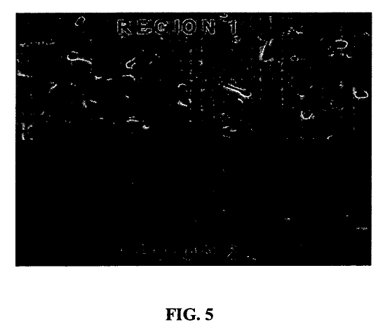

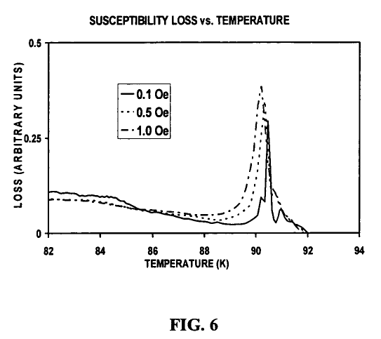

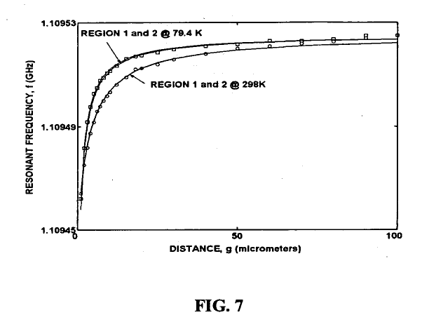

In this embodiment, an YBa₂Cu₃O_{7-δ} superconducting thin film is fabricated by pulsed laser deposition. This deposition method results in two distinct regions, 1 and 2, forming on a 0.5 mm thick LaAlO₃ substrate (see FIG. 5). The superconductive transition temperatures for region 1 and 2 of the film are T_{c}=92 K and 90 K respectively, which are measured by plotting susceptibility loss versus temperature under different amplitudes of alternating magnetic field at the frequency of 2 MHz, as shown in FIG. 6. The measured frequency shift data is collected for both regions at 79.4 K and 298 K as shown in FIG. 7. Fitting parameters from (8) to our experimental data are consolidated in Table I.

TABLE I
SIMULATION FIT PARAMETERS FOR YBa₂Cu₃O_{7-□}
SUPERCONDUCTING THIN FILM AT 79.4K AND 298K.

| | A | ε′/ε₀ | | r₀ | μ/μ₀ |
|---|---|---|---|---|---|
| REGIONS | (10⁻⁴) | (10⁸) | ε″/ε₀ | (10⁻⁶ m) | (10⁻⁴) |
| REGION 1 at 79.4K | 2.09 | −9.2 | −0.1 | 3.35 | 1 |
| REGION 2 at 79.4K | 2.08 | −9 | −0.1 | 3.35 | 1 |
| TRANSITION | 2.08 | −9.1 | −0.1 | 3.35 | 1 |
| REGION at 79.4K | | | | | |
| REGION 1 at 298K | 1.45 | 1 | 6.6 | 8 | 1 |
| REGION 2 at 298K | 1.45 | 1 | 6.85 | 8 | 1 |

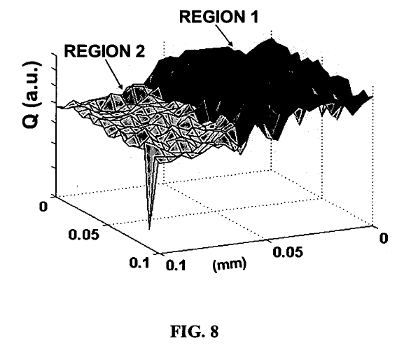

Above the transition temperature (T_{c}), the superconductor behaves like a metallic conductor, which changes the sign and magnitude of the real and imaginary permittivity values (Table I). FIG. 7 shows the curves from both regions below T_{c} and illustrates that there is a distinct measurable difference between these regions. The transition section connecting region 1 and 2 with the associated frequency shift fit parameters generated at 79.4 K falls in between fit curves for regions 1 and 2. The model fit parameters for this transition segment are A=2.08×10⁻⁴, which is the resonator scaling factor, the real component of permittivity ε′=−9.13×10⁸ ε₀, the imaginary component of permittivity ε″=−0.1 ε₀, and the effective tip radius r₀=3.35 μm. FIG. 8 shows a change in Q scan performed at 79.4 K over both regions and indicates the average dynamic range of Q in this scan between the two areas is approximately 8000 , with the higher Q level associated with the area of T_{c}=92 K and the lower Q level corresponding to region of T_{c}=90 K.

System Resolution

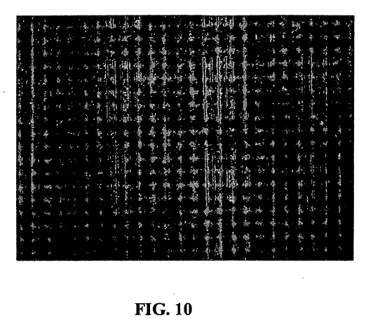

The resolution of the probe is verified using a sapphire polycrystalline substrate with titanium-gold etched lines of widths ranging from 10 μm to 1 μm (see FIG. 10). The titanium is used to permit adhesion of the gold to the substrate and is approximately 100 nm thick, while the deposition thickness of the gold is approximately 1 μm. The resonant frequency of the probe is tuned to 2.67 GHz. The etched lines of the sample are scanned with the probe resulting in a change in frequency, Q, and magnitude of reflection plots.

The smallest physically resolvable feature for an evanescent probe is governed by the size of the tip radius, along with the height at which the tip is positioned above the feature. For example, to resolve a 5 μm physical feature, the probe tip radius r₀ must be less than or equal to 5 μm and should be no more than g=5 μm above it, where g is the distance from tip to sample.

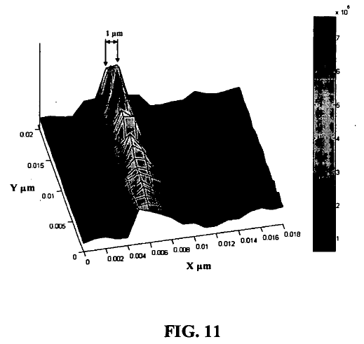

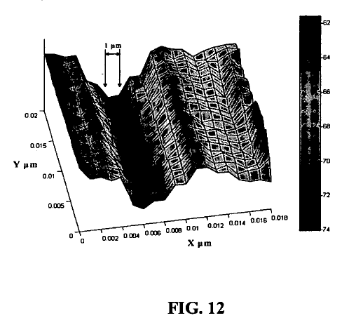

The change in Q and change in magnitude of reflection coefficient images are illustrated in FIGS. 11 and 12, respectively. The data for these plots are taken from a 20 μm×18 μm scan area around a 1 μm wide etched line. The measured tip radius of the probe used is 1.2 μm with a stand off height of 2 μm and a 1 μm data acquisition step. The location of the etched line is indicated on each plot by arrows with corresponding measurements in micrometers. The one micrometer line was distinguishable in both plots, which gives the probe at least about 1 μm topographical resolution. The Q values that are attainable with this tunable resonator range from 1.5×10⁴ to well over 10⁵. The dynamic range of the change in Q is approximately 5×10⁵ as shown in FIG. 11.

System Sensitivity

The Johnson noise limited sensitivity is analyzed for the present invention by setting the signal power equal to the noise power resulting in [(δε/ε)]=2.45×10⁻⁵.

The sensitivity of the evanescent microwave probe described here can be separated into two categories. The first Sᵣ is inherent to the resonator itself and directly proportional to it's quiescent operating value Q. The other S_{f} is external to the resonator and solely determined by the tip-sample interaction. A noise threshold has to be considered in an evanescent microwave system, which also affects sensitivity.

The minimum detectable signal in an evanescent microwave microscopy system has to be greater than the noise threshold created by the resonator probe, tuning network, and coupling to the sample. The noise is generated by a resistance at an absolute temperature of T by the random motion of electrons proportional to the temperature T within the resistor. This generates random voltage fluctuations at the resistor terminal, which has a zero average value, but a nonzero rms value given by Planck's black body radiation law and can be calculated by the Raleigh-Jeans approximation [7] as
Vₙ₍ᵣₘₛ₎=\sqrt{4kTBR} (11)
where k=1.38×10⁻²³ J/K is Boltzmann's constant, T is the temperature in K, B is the bandwidth of the system in Hz, and R is the resistance in Ω. The resistance that results at critical coupling is the resistance R that produces noise in the system. Therefore, the signal level is required to be above this noise level for detection.
Resonator Sensitivity Sᵣ

The sensitivity approximation internal to the resonator Sᵣ can be determined theoretically and experimentally. The theoretical value is analytically approximated by considering the lumped series equivalent circuit of the resonator, which has an inherent resonant frequency ω₀ and Q associated with the lumped parameters R₀, L₀, and C₀. This configuration and associated parameters can be viewed as if the probe tip is beyond the decay length of the evanescent field from a material, or in free space. If the probe tip is brought into close proximity and electrically couples to the sample, the resonant frequency ω₀ and Q are perturbed to a new value ω′₀ and Q′, respectively, and are associated with new perturbed parameters R′₀, L′₀, and C′₀. The total impedance looking into the terminals of the perturbed resonator coupled to a sample can be written as

$${Z}_{TOTAL} = {R}_{0}^{′} [ 1 + j {Q}^{′} ( \frac{ω}{{ω}_{0}^{′}} - \frac{{ω}_{0}^{′}}{ω} ) ] . \qquad ( 12 )$$

The magnitude of the reflection coefficient S₁₁ is related to Z_{TOTAL} by

$${S}_{11} = \frac{{Z}_{TOTAL} - {Z}_{0}}{{Z}_{TOTAL} + {Z}_{0}} , \qquad ( 13 )$$

where Z₀ is the characteristic impedance of the resonant structure. If we assume critical coupling, where the resonator is matched to the characteristic impedance of the feed transmission line at resonant frequency, then R′₀≈Z₀ at ω≈ω′₀ and Sᵣ is defined in [5] as

$${S}_{r} = \frac{ⅆ {S}_{11}}{ⅆ ω} \approx \frac{{Q}^{′}}{{ω}_{0}^{′}} ( 1 - \frac{Δω}{{ω}_{0}^{′}} ) , \qquad ( 14 )$$

where Δω=ω−ω′₀.
Probe Sensitivity S_{f}

The external sensitivity determined by tip-sample interaction of the resonator is based on a λ/4 section of transmission line, with the lumped parameter series equivalent circuit coupled to an equivalent circuit model of a superconductor shown in FIG. 7. The series lumped parameter circuit for the resonator consists of R₀, L₀, and C₀ and the probe tip coupling to the superconductor is represented by C_{C}. The equivalent circuit model of the superconductor is comprised of R_{S}, L_{S}, C_{S}, and L_{C}, where the series combination of R_{S} and L_{S} represents the normal conduction. The element L_{C} signifies the kinetic inductance of the Cooper-pair flow and C_{S} is related to displacement current. The superconductor equivalent circuit contains the necessary circuit elements in the appropriate configuration to represent not only a superconductor, but a metallic conductor and a dielectric.

The equivalent circuit model for the probe coupled to a superconductor is illustrated in FIG. 7, where the equivalent circuit model for the superconductor is derived from the two- fluid model [8]. The lumped circuit representation of the superconductor consists of capacitance C_{S}, the inductance for normal carrier flow L_{S}, and resistivity ρ=1/σ₁ shunted by kinetic inductance L_{C}=1/ωσ₂. The parameters C_{S} and L_{S} are considered to have minimal effects [8] when the superconductor is subjected to low frequencies and is neglected in this analysis. The conductivity ratio y=σ₁/σ₂ is correlated to the impedance ratio y=ωL_{C}/ρ and in the limit of large y (y>>1), σ₂=0 and L_{C}>>1 [8]. The opposite extreme, y<<1 results in L_{C} approaching 0, while σ₂ advances toward infinity. The superconductive samples for this study were subjected to a frequency of approximately 1 GHz and are of an inductive nature. The superconductor with an inductive nature has L_{C}<<R_{S}.

The impedance Z₁ is the parallel combination of R_{S} and L_{C} and is represented as

$${Z}_{1} = \frac{jω {L}_{C} {R}_{S}}{{R}_{S} + jω {L}_{C}} . \qquad ( 15 )$$

The impedance Z₂ is the series combination of C_{C} and Z_{1,} which results in

$${Z}_{2} = \frac{1}{jω {C}_{C}} + \frac{jω {L}_{C} {R}_{S}}{{R}_{S} + jω {L}_{C}} = \frac{{R}_{S} + jω {L}_{C} + jω {C}_{C} ( jω {L}_{C} {R}_{S} )}{jω {C}_{C} ( {R}_{S} + jω {L}_{C} )} . \qquad ( 16 )$$

The impedance Z₃ is the parallel combination of Z₂ and C₀ given by

$$\frac{1}{{Z}_{3}} = \frac{1}{{Z}_{2}} + jω {C}_{0} = \frac{jω {C}_{C} ( {R}_{S} + jω {L}_{C} )}{{R}_{S} + jω {L}_{C} + jω {C}_{C} ( jω {L}_{C} {R}_{S} )} + {jωC}_{0} \\ \begin{matrix}{Z}_{3} = \frac{{R}_{S} - {ω}^{2} {L}_{C} {C}_{C} {R}_{S} + jω {L}_{C}}{jω {C}_{C} ( {R}_{S} + jω {L}_{C} ) + {C}_{0} ( {R}_{S} - {ω}^{2} {L}_{C} {C}_{C} {R}_{S} + jω {L}_{C} )} \\ = - \frac{j}{ω} [ \frac{{R}_{S} - {ω}^{2} {L}_{C} {C}_{C} {R}_{S} + jω {L}_{C`}}{{C}_{C} ( {R}_{S} + jω {L}_{C} ) + {C}_{0} ( {R}_{S} - {ω}^{2} {L}_{C} {C}_{C} {R}_{S} + jω {L}_{C} )} ] \\ = - \frac{j}{ω} {Z}_{3}^{′} .\end{matrix} \qquad ( 17 )$$

The total impedance Z_{TOTAL} looking into the terminals of the probe coupled to a superconductor sample is

$${Z}_{total} = {R}_{0} + jω {L}_{0} - \frac{j}{ω} {Z}_{3}^{′} .$$

The complex impedance Z₃ can be represented as

$${Z}_{3} = \frac{1}{jω} [ Re ( {Z}_{3}^{′} ) ] = - \frac{j}{ω} [ Re ( {Z}_{3}^{′} ) ] .$$

At resonance, the inductive and capacitive reactances cancel; therefore,

$$jω {L}_{0} - \frac{j}{ω} [ Re ( {Z}_{3}^{′} ) ] = 0 , \\ {ω}^{2} {L}_{0} = Re ( {Z}_{3}^{′} ) . \qquad ( 18 )$$

This allows us to solve for perturbed frequency ω in terms of the perturbed lumped circuit parameters in an iterative process, where we will be taking a first-order approximation. The combination of (7) and (8) results in

$$\begin{matrix}{ω}^{2} {L}_{0} = \frac{{R}_{S}^{2} ( 1 - {ω}^{2} {L}_{C} {C}_{C} ) ( {C}_{C} + {C}_{0} - {ω}^{2} {C}_{0} {L}_{C} {C}_{C} )}{{{R}_{S}^{2} ( {C}_{C} + {C}_{0} - {ω}^{2} {C}_{0} {L}_{C} {C}_{C} )}^{2} + {ω}^{2} {{L}_{C}^{2} ( {C}_{C} + {C}_{0} )}^{2}} \\ = \frac{1}{( {C}_{C} + {C}_{0} )} \frac{( 1 - {ω}^{2} {L}_{C} {C}_{C} - {ω}^{2} {L}_{C} \frac{{C}_{0} {C}_{C}}{{C}_{C} + {C}_{0}} )}{( 1 - 2 {ω}^{2} {L}_{C} \frac{{C}_{0} {C}_{C}}{{C}_{C} + {C}_{0}} )} \\ = \frac{1}{( {C}_{C} + {C}_{0} )} \\ \frac{1}{( 1 - 2 {ω}^{2} {L}_{C} \frac{{C}_{0} {C}_{C}}{{C}_{C} + {C}_{0}} ) [ 1 + {ω}^{2} {L}_{C} {C}_{C} ( 1 + \frac{{C}_{0}}{{C}_{C} + {C}_{0}} ) ]} \\ = \frac{1}{( {C}_{C} + {C}_{0} )} \frac{1}{1 + {ω}^{2} {L}_{C} \frac{{C}_{C}^{2}}{{C}_{C} + {C}_{0}}} .\end{matrix} \qquad ( 19 )$$

Therefore, for the first iteration, we have the equation

$${ω}_{0}^{′2} = \frac{1}{{L}_{0} ( {C}_{C} + {C}_{0} )} \frac{1}{[ 1 + \frac{{L}_{C}}{{L}_{0}} {( \frac{{C}_{C}}{{C}_{C} + {C}_{0}} )}^{2} ]} . \qquad ( 20 )$$

Solving for ω′₀ in (20) results in

$${ω}_{0}^{′} = {ω}_{0} \frac{1}{\sqrt{1 + \frac{{C}_{C}}{{C}_{0}}}} \frac{1}{\sqrt{1 + \frac{{L}_{C}}{{L}_{0}}} {( \frac{{C}_{C}}{{C}_{C} + {C}_{0}} )}^{2}} , \qquad ( 21 )$$

Where

$$\frac{{L}_{C}}{{L}_{0}} ⪡ 1.$$

The Taylor expansion of (21) gives

$${ω}_{0}^{′} = {ω}_{0} ( 1 - \frac{1}{2} \frac{{C}_{C}}{{C}_{0}} ) [ 1 - \frac{1}{2} \frac{{L}_{C}}{{L}_{0}} \frac{{C}_{C}^{2}}{{( {C}_{0} + {C}_{C} )}^{2}} ] . \qquad ( 22 )$$

The sensitivity S_{f} for a superconductor is defined as

$${S}_{f} = \frac{{g}_{S} {R}_{S}^{2}}{2 π} \vert \frac{ⅆ {ω}_{0}^{′}}{ⅆ {L}_{C}} \vert , \qquad ( 23 )$$

where

$${g}_{S} = \frac{{A}_{eff}}{{λ}_{L}} ,$$

A_{eff} is the effective tip area, and λ_{L} is the London penetration depth. Therefore, the sensitivity S_{f} for a superconductor is found by taking the derivative of ω′₀ with respect to L_{C} in (22) and is given by

$${S}_{f} = \frac{{g}_{S} {R}_{S}^{2}}{2 π} {ω}_{0} ( 1 - \frac{{C}_{C}}{2 {C}_{0}} ) [ \frac{1}{( 2 {L}_{0} )} \frac{{C}_{C}^{2}}{{( {C}_{C} + {C}_{0} )}^{2}} ] . \qquad ( 24 )$$

The ability of the probe to differentiate between regions of different conductivity within a superconductor Δσ/σ is defined as

$$\frac{Δ σ}{σ} = ( \frac{{V}_{n ( rms )}}{{V}_{in}} ) / {S}_{f} {S}_{r} σ . \qquad ( 25 )$$

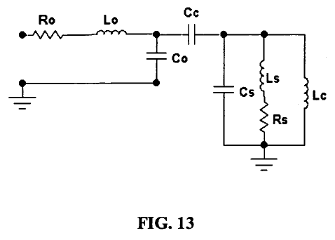

The probe couples to a metallic sample through the coupling capacitance C_{C} and the conductor is represented as the series combination of R_{S} and L_{S}. An equivalent circuit of a metallic sample does not contain the circuit elements L_{C} and C_{S} in the two-fluid equivalent circuit (see FIG. 13). Therefore, C_{S}=0 and L_{C}=∞. The impedance Z₁ is the series combination of C_{C}, R_{S}, and L_{S} and is represented as

$$\begin{matrix}{Z}_{1} = {R}_{S} + j ω {L}_{S} + \frac{1}{j ω {C}_{C}} \\ = \frac{1 + j ω {C}_{C} {R}_{S} - {ω}^{2} {L}_{S} {C}_{C}}{j ω {C}_{C}} .\end{matrix} \qquad ( 26 )$$

The parallel combination of Z₁ and C₀ results in

$$\begin{matrix}\frac{1}{{Z}_{2}} = j ω {C}_{0} + \frac{j ω {C}_{C}}{( 1 - {ω}^{2} {L}_{S} {C}_{C} ) + j ω {C}_{C} {R}_{S}} & \\ = \frac{j ω {C}_{0} ( 1 - {ω}^{2} {L}_{S} {C}_{C} ) + j ω {C}_{C} - {ω}^{2} {C}_{0} {C}_{C} {R}_{S}}{( 1 - {ω}^{2} {L}_{S} {C}_{C} ) + j ω {C}_{C} {R}_{S}} & \\ = \frac{j ω [ {C}_{C} + {C}_{0} ( 1 - {ω}^{2} {L}_{S} {C}_{C} ) - {ω}^{2} {C}_{0} {C}_{C} {R}_{S} ]}{1 - {ω}^{2} {L}_{S} {C}_{C} + j ω {C}_{C} {R}_{S}} , & \\ and the impedance {Z}_{2} is & \\ {Z}_{2} = \frac{( 1 - {ω}^{2} {L}_{S} {C}_{C} ) + j ω {C}_{C} {R}_{S}}{j ω [ {C}_{C} {C}_{0} ( 1 - {ω}^{2} {L}_{S} {C}_{C} ) - {ω}^{2} {C}_{0} {C}_{C} {R}_{S} ]} & ( 27 ) \\ = - \frac{j}{ω} {Z}_{2}^{′} . & \end{matrix}$$

The total impedance Z_{TOTAL} looking into the terminals of the probe coupled to a conductor sample is

$${Z}_{TOTAL} = {R}_{0} + j ω {L}_{0} - \frac{j}{ω} {Z}_{2}^{′} .$$

The complex impedance Z₃ can be represented as

$$\begin{matrix}{Z}_{2} = \frac{1}{j ω} [ Re ( {Z}_{2}^{′} ) ] \\ = - \frac{j}{ω} [ Re ( {Z}_{2}^{′} ) ] .\end{matrix}$$

At resonance, the inductive and capacitive reactance cancel; therefore,

$$\begin{matrix}j ω {L}_{0} - \frac{j}{ω} [ Re ( {Z}_{2}^{′} ) ] = 0 , \\ {ω}^{2} {L}_{0} = Re ( {Z}_{2}^{′} ) .\end{matrix} \qquad ( 28 )$$

The impedance Z′₂ is represented as

$${Z}_{2}^{′} = \frac{( 1 - {ω}^{2} {L}_{S} {C}_{C} ) + j ω {C}_{C} {R}_{S}}{[ {C}_{C} + {C}_{0} ( 1 - {ω}^{2} {L}_{S} {C}_{C} ) + j ω {C}_{0} {C}_{C} {R}_{S} ]} . \qquad ( 29 )$$

Taking the real part of (29), we have

$$\begin{matrix}Re ( {Z}_{2}^{′} ) = \frac{( 1 - {ω}^{2} {L}_{S} {C}_{C} ) [ {C}_{C} + {C}_{0} ( 1 - {ω}^{2} {L}_{S} {C}_{C} ) ] + {ω}^{2} {C}_{0} {C}_{C}^{2} {R}_{S}^{2}}{{[ {C}_{C} + {C}_{0} ( 1 - {ω}^{2} {L}_{S} {C}_{C} ) ]}^{2} + {ω}^{2} {C}_{0}^{2} {C}_{C}^{2} {R}_{S}^{2}} \\ = \frac{{C}_{C} ( 1 - {ω}^{2} {L}_{S} {C}_{C} ) + {{C}_{0} ( 1 - {ω}^{2} {L}_{S} {C}_{C} )}^{2} + {ω}^{2} {C}_{0} {C}_{C}^{2} {R}_{S}^{2}}{{[ {C}_{C} + {C}_{0} ( 1 - {ω}^{2} {L}_{S} {C}_{C} ) ]}^{2} + {ω}^{2} {C}_{0}^{2} {C}_{C}^{2} {R}_{S}^{2}} .\end{matrix} \qquad ( 30 )$$

The numerator and denominator of (30) are considered separately, so the numerator is expanded and results in
(C_{C}+C₀)−ω²(L_{S}C_{C}²+2C₀L_{S}C_{C}−C₀C_{C}²R_{S}²)+ω⁴C₀C_{C}²L_{S}² (31)

The ω⁴ term in (31) is discarded due to insignificance and the denominator of (30) is expanded as
(C_{C}+C₀−ω²L_{S}C_{C}C₀)²+ω²C₀²C_{C}²R_{S}²=(C_{C}+C₀)²−2ω²L_{S}(C_{C}+C₀)C_{C}C₀+ω⁴C₀²C_{C}²L_{S}²+ω²C₀²C_{C}²R_{S}² (32)

Likewise, the ω⁴ term in (32) is neglected and the combination of (31) and (32) appear as

$$\frac{( {C}_{C} + {C}_{0} ) - {ω}^{2} ( {L}_{S} {C}_{C}^{2} + 2 {C}_{0} {L}_{S} {C}_{C} - {C}_{0} {C}_{C}^{2} {R}_{S}^{2} )}{{( {C}_{C} + {C}_{0} )}^{2} - 2 {ω}^{2} {L}_{S} ( {C}_{C} + {C}_{0} ) {C}_{0} {C}_{C} + {ω}^{2} {C}_{0}^{2} {C}_{C}^{2} {R}_{S}^{2}} . \qquad ( 33 )$$

Factoring out (C_{C}+C₀) in numerator and denominator of (33) and substituting the result into (28) produces

$${ω}^{2} {L}_{0} = \frac{1}{( {C}_{C} + {C}_{0} )} \frac{1 - {ω}^{2} \frac{( {L}_{S} {C}_{C}^{2} + 2 {C}_{0} {L}_{S} {C}_{C} - {C}_{0} {C}_{C}^{2} {R}_{S}^{2} )}{( {C}_{C} + {C}_{0} )}}{1 - 2 {ω}^{2} \frac{{L}_{S} {C}_{C} {C}_{0}}{( {C}_{C} + {C}_{0} )} + {ω}^{2} \frac{{C}_{0}^{2} {C}_{C}^{2} {R}_{S}^{2}}{{( {C}_{C} + {C}_{0} )}^{2}}} . \qquad ( 34 )$$

Reducing (34) and multiplying by

$$1 + {ω}^{2} \frac{[ {L}_{S} {C}_{C} ( {C}_{C} + 2 {C}_{0} ) - {C}_{0} {C}_{C}^{2} {R}_{S}^{2} ]}{( {C}_{C} + {C}_{0} )} ,$$

results in

$${ω}^{2} {L}_{0} = \frac{1}{( {C}_{C} + {C}_{0} )} \frac{1}{1 + {ω}^{2} \frac{{L}_{S} {C}_{C}^{2}}{( {C}_{C} + {C}_{0} )} + {ω}^{2} \frac{{C}_{0} {C}_{C}^{2} {R}_{S}^{2}}{( {C}_{C} + {C}_{0} )} ( \frac{{C}_{0}}{{C}_{C} + {C}_{0}} - 1 )} . \qquad ( 35 )$$

The relation ω₀²/(1+C_{C}/C₀) with ω₀²=1/L₀C₀ as a zero-order approximation to our iterative process is substituted into (35) producing a first-order approximation

$${ω}_{0}^{{′}^{2}} = \frac{1}{{L}_{0} ( {C}_{C} + {C}_{0} )} \frac{1}{1 + \frac{{L}_{S}}{{L}_{0}} {( \frac{{C}_{C}}{{C}_{C} + {C}_{0}} )}^{2} - \frac{{C}_{0} {R}_{S}^{2}}{{L}_{0}} {( \frac{{C}_{C}}{{C}_{C} + {C}_{0}} )}^{3}} . \qquad ( 36 )$$

Rewriting (36) and taking the square root of both sides and neglecting higher-order terms, we have the first-order approximation for the perturbed resonant frequency due to the coupling of the probe to a conductor.

$${ω}_{0}^{′} = {ω}_{0} \frac{1}{\sqrt{1 + \frac{{C}_{C}}{{C}_{0}}}} \frac{1}{\sqrt{1 + \frac{{L}_{S}}{{L}_{0}} {( \frac{{C}_{C}}{{C}_{C} + {C}_{0}} )}^{2}}} . \qquad ( 37 )$$

The Taylor expansion of (37) gives

$${ω}_{0}^{′} = {ω}_{0} ( 1 - \frac{{C}_{C}}{2 {C}_{0}} ) [ 1 - \frac{{L}_{S}}{2 {L}_{0}} \frac{{C}_{C}^{2}}{{( {C}_{C} + {C}_{0} )}^{2}} ] . \qquad ( 38 )$$

The sensitivity S_{f} for a conductor is defined as

$${S}_{f} = \frac{{g}_{S} {R}_{S}^{2}}{2 π} \vert \frac{ⅆ {ω}_{0}^{′}}{ⅆ {L}_{S}} \vert , \qquad ( 39 )$$

where

$${g}_{S} = \frac{{A}_{eff}}{δ} ,$$

A_{eff} is the effective tip area, and δ is the skin depth. Therefore, the sensitivity S_{f} (39) for a conductor is found by taking the derivative of ω′₀ with respect to L_{S} in (38) and results in

$${S}_{f} = \frac{{g}_{S} {R}_{S}^{2}}{2 π} {ω}_{0} ( 1 - \frac{{C}_{C}}{2 {C}_{0}} ) [ \frac{1}{2 {L}_{0}} \frac{{C}_{C}^{2}}{{( {C}_{C} + {C}_{0} )}^{2}} ] . \qquad ( 40 )$$

The ability of the probe to differentiate between regions of different conductivity Δσ/σ is defined as

$$\frac{Δ σ}{σ} = ( \frac{{V}_{n ( rms )}}{{V}_{in}} ) / {S}_{f} {S}_{r} σ , \qquad ( 31 )$$

where vₙ₍ᵣₘₛ₎ is given in (11) and vᵢₙ is the probe input voltage.

The probe also couples to a dielectric sample through the coupling capacitance C_{C} and the dielectric is represented as the parallel combination of R_{S} and C_{S}. The equivalent circuit of an insulating sample does not contain the circuit elements L_{C} and L_{S} from the two-fluid equivalent circuit. Therefore, L_{S}=0 and L_{C}=∞. The impedance Z₁ is the parallel combination of R_{S} and C_{S} and is represented as

$${Z}_{1} = \frac{{R}_{S}}{jω {C}_{S} {R}_{S} + 1} . \qquad ( 42 )$$

The series combination of Z₁ and C_{C} result in

$${Z}_{2} = \frac{1}{j ω {C}_{C}} + \frac{1}{j ω {C}_{S} {R}_{S} + 1} = \frac{1 + jω {C}_{S} {R}_{S} + jω {C}_{C} {R}_{S}}{jω {C}_{C} ( jω {C}_{S} {R}_{S} + 1 )} . \qquad ( 43 )$$

The impedance Z₃ is the parallel combination of Z₂ and C₀ and is represented as

$$\frac{1}{{Z}_{3}} = \frac{jω {C}_{C} ( 1 + jω {C}_{S} {R}_{S} )}{( 1 + jω {C}_{C} {R}_{S} + jω {C}_{S} {R}_{S} )} + jω {C}_{0} , \\ {Z}_{3} = \frac{1 + jω {C}_{C} {R}_{S} + jω {C}_{S} {R}_{S}}{jω {C}_{C} ( 1 + jω {C}_{S} {R}_{S} ) + jω {C}_{0} ( 1 + jω {C}_{C} {R}_{S} + jω {C}_{S} {R}_{S} )} = - \frac{j}{ω} {Z}_{3}^{′} . \qquad ( 44 )$$

The total impedance Z_{TOTAL} looking into the terminals of the probe coupled to a dielectric sample is

$${Z}_{TOTAL} = {R}_{0} + jω {L}_{0} - \frac{j}{ω} {Z}_{3}^{′} .$$

The complex impedance Z₃ can be represented as

$${Z}_{3} = \frac{1}{jω} [ Re ( {Z}_{3}^{′} ) ] = - \frac{j}{ω} [ Re ( {Z}_{3}^{′} ) ] .$$

At resonance, the inductive and capacitive reactance cancel; hence,

$$jω {L}_{0} - \frac{j}{ω} [ Re ( {Z}_{3}^{′} ) ] = 0 , \\ {ω}^{2} {L}_{0} = Re ( {Z}_{3}^{′} ) . \qquad ( 45 )$$

The quantity jωR_{S} is factored out in the numerator and denominator of (44) and the result is placed into (45), giving

$$\begin{matrix}{ω}^{2} {L}_{0} = Re \{ \frac{1 + jω {R}_{S} ( {C}_{C} + {C}_{S} )}{( {C}_{C} + {C}_{0} ) + jω {R}_{S} [ {C}_{C} {C}_{S} + {C}_{0} ( {C}_{C} + {C}_{S} ) ]} \} \\ = \frac{( {C}_{C} + {C}_{0} ) + {ω}^{2} {R}_{S}^{2} ( {C}_{C} + {C}_{S} ) [ {C}_{C} {C}_{S} + {C}_{0} ( {C}_{C} + {C}_{S} ) ]}{{( {C}_{C} + {C}_{0} )}^{2} + {ω}^{2} {{R}_{S}^{2} [ {C}_{C} {C}_{S} + {C}_{0} ( {C}_{C} + {C}_{S} ) ]}^{2}} .\end{matrix}$$

R_{S} is neglected since it is large, so

$$\begin{matrix}{ω}^{2} {L}_{0} \approx \frac{( {C}_{C} + {C}_{S} )}{{C}_{C} {C}_{S} + {C}_{0} ( {C}_{C} + {C}_{S} )} \\ = \frac{1}{{C}_{0}} \frac{1}{[ 1 + \frac{{C}_{C} {C}_{S}}{{C}_{0} ( {C}_{C} + {C}_{S} )} ]} .\end{matrix}$$

Therefore,

$${ω}_{0}^{{′}^{2}} = \frac{1}{{L}_{0} {C}_{0}} \frac{1}{[ 1 + \frac{{C}_{C} {C}_{S}}{{C}_{0} ( {C}_{C} + {C}_{S} )} ]} . \qquad ( 46 )$$

Solving for ω′₀ in (46) results in

$${ω}_{0}^{′} = {ω}_{0} \frac{1}{\sqrt{1 + \frac{{C}_{C} {C}_{S}}{{C}_{0} ( {C}_{C} + {C}_{S} )}}} . \qquad ( 47 )$$

The Taylor expansion of (47) gives

$${ω}_{0}^{′} = {ω}_{0} [ 1 - \frac{{C}_{C} {C}_{S}}{2 {C}_{0} ( {C}_{C} + {C}_{S} )} ] . \qquad ( 48 )$$

The sensitivity S_{f} for a dielectric is defined as

$${S}_{f} = \frac{{g}_{S}}{2 π} \vert \frac{ⅆ {ω}_{0}^{′}}{ⅆ {C}_{S}} \vert , \qquad ( 49 )$$

where

$${g}_{S} = \frac{{A}_{eff}}{{ξ}_{S}} ,$$

A_{eff} is the effective tip area, and ξₛ is the decay length of the evanescent wave, which is approximately 100 μm. Therefore, the sensitivity S_{f} for a dielectric is found by taking the derivative of ω′₀ with respect to C_{S} in (48)

$${S}_{f} = \frac{{g}_{S} {ω}_{0}}{4 π} \frac{{C}_{C}^{2}}{{{C}_{0} ( {C}_{C} + {C}_{S} )}^{2}} . \qquad ( 50 )$$

The ability of the probe to differentiate between regions of different permittivity Δε/ε is defined as

$$\frac{Δ ɛ}{ɛ} = ( \frac{{V}_{n ( rms )}}{{V}_{in}} ) / {S}_{f} {S}_{r} ɛ . \qquad ( 51 )$$

The experimental verification of the sensitivity for superconductors is performed on a YBa₂Cu₃O₇₋₆₇ coated SrTiO₃ bi-crystal of 60° orientation mismatch. Resonant frequency shift measurements are taken, resulting in complex permittivity values for two separate locations below T_{c} at 79.4 K. The measurements are taken in the boundary at points C and D shown in FIG. 8. The sensitivities given by (14), (24), and (25) are listed in Table II.

TABLE II
SENSITIVITY AND ASSOCIATED PARAMETERS
FOR SUPERCONDUCTORS

| | ε′/ε₀ (10⁸) | Sᵣ | S_{f} | Δσ/σ |
|---|---|---|---|---|
| Position C | −8.94 | 9.03 × 10⁻⁶ | 1.13 × 10⁻⁶ | 1.0 × 10⁻² |
| Position D | −8.87 | 1.04 × 10⁻⁵ | 1.13 × 10⁻⁶ | 8.6 × 10⁻³ |

The sensitivity parameters comprise C_{C}=1.36×10⁻¹⁵ F, C₀=8.91×10⁻¹² F, L₀=2.03×10⁻⁸ H, R_{S}=1×10⁻⁶ ΩQ, σ=3.3×10⁸ S/m, and gₛ=1.02×10⁻³ The experimental results show that Δσ/σ≅7.8×10⁻³.

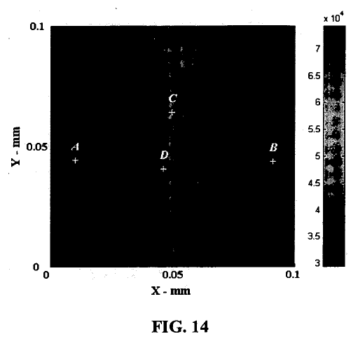

The experimental verification of the sensitivity for conductors is also performed on the YBa₂Cu₃O_{7-δ} coated SrTiO₃ bi-crystal of 60° orientation mismatch. The measurements are taken at the same locations for the superconductor sensitivity, in the boundary at points C and D (FIG. 14) at a temperature of 300 K. The sensitivities given by (14), (40), and (41) are listed in Table III. The sensitivity parameters consist of C_{C}=1.36×10⁻¹⁵ F, C₀=8.91×10⁻¹² F, L₀=2.03×10⁻⁸ H, R_{S}=7.76×10⁻⁴ Ω[8], σ=1.28×10³ S/m, and g_{c}=1.54×10⁻⁴. The experimental results have shown that Δσ/σ≅2.4×10⁻².

TABLE III
SENSITIVITY AND ASSOCIATED
PARAMETERS FOR CONDUCTORS

| | ε″/ε₀ | Sᵣ | S_{f} | Δσ/σ |
|---|---|---|---|---|
| Position C | 6.3 | 6.83 × 10⁻⁶ | 5.9 × 10⁻² | 8.36 × 10⁻² |
| Position D | 6.15 | 5.95 × 10⁻⁶ | 5.9 × 10⁻² | 9.91 × 10⁻² |

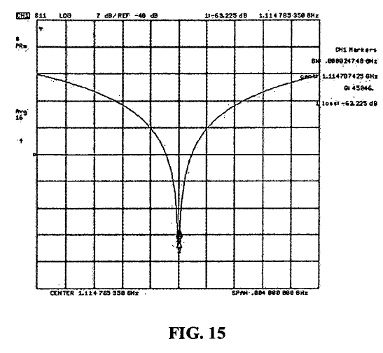

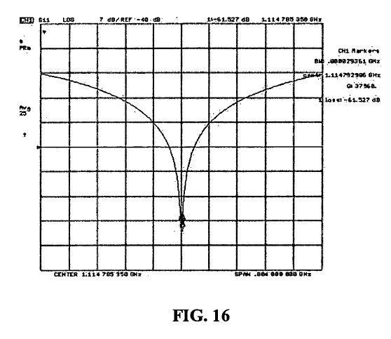

The experimental verification of the sensitivity for dielectrics is performed on single crystal SrTiO₃ utilizing the ferroelectric dependence on temperature property of the material, i.e., εᵣ=f(7). The probe tip is set to a 1 μm distance above the sample and tuned to a resonant frequency of 1.114787 GHz at a temperature of 300 K and is illustrated in FIG. 15. The temperature is raised in 0.2 K increments until the resonance shifted in frequency to 1.114792 GHz at 302 K due to the change in dielectric constant and is shown in FIG. 16. The change in dielectric constant is determined using the Curie-Weiss law and results in Δε/ε≅6.23×10⁻³. The sensitivity parameters consist of ε′/ε₀=320.8, C_{C}=1.36×10⁻¹⁵ F, C₀=8.91×10⁻¹² F, C_{S}=4.37×10⁻¹⁵ F, and gₛ=1.54×10⁻⁶. The lowest theoretically estimated change in permittivity that can be detected by the sensor was Δε/ε=5.75×10⁻⁴.

It is noted that terms like “preferably,” “commonly,” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

What is claimed is:

1. An evanescent microwave microscopy probe substantially as described in the above specification and in the accompanying drawings including one or more of the novel features described in the above specification and drawings.

2. An evanescent microwave microscopy probe comprising:
a dielectric support member, and
a conductor transmission line comprising at least one electrically isolated conductive element extending along the length of said dielectric support member and forming a tapered probe tip;
an electrically conductive sheath mounted on said dielectric support member said sheath enclosing said electrically isolated conductive element and forming a wave guide.

3. A method of investigating the complex permittivity of a material through evanescent microwave technology as described in the above specification and in the accompanying drawings including one or more of the novel features described in the above specification and drawings.
